(19) United States
(12) Patent Application Publication
(10) Pub. No.: US 2025/0283327 A1
(43) Pub. Date: Sep. 11, 2025

(54) PARTITION SYSTEM FOR DIVIDING A ROOM OF A BUILDING INTO A PLURALITY OF ROOMS

(71) Applicant: FOURHUNDREDFIFTY INC., New York, NY (US)

(72) Inventor: DOMENICO GUZZARDI, Edgewater, NJ (US)

(21) Appl. No.: 18/599,511

(22) Filed: Mar. 8, 2024

(51) Int. Cl. E04B 2/74; E06B 3/36; E06B 3/46; E06B 3/70; E06B 3/72

(52) U.S. Cl. CPC E04B 2/7448; E06B 3/36; E06B 3/4636; E06B 3/725; E04B 2002/7461; E06B 2003/7059

(57) ABSTRACT

A partition system (10) for dividing a space, comprising a frame (11) and one or more partition panels (12) mountable on the frame, wherein the frame comprises a plurality of main profiles (100) which comprises at least one plurality of perimetric profiles (110) configured to be fixed to a surface of the space; one or more perimetric profiles are constituted of a main material which is thermoplastic polyolefin mixture-based. Each main profile delimits a first front hollow (102) which, in use, receives an edge (13) of at least one of the partition panels. The frame comprises a plurality of covering profiles (200) which are couplable by means of a snap joint to the plurality of main profiles, and which comprises a plurality of first covers (201) couplable in such a way as to close the first front hollow at the first lateral side obstructing removal of the partition panel.

### DESCRIPTION

This invention relates to a partition system for dividing a space of a building into a plurality of rooms. The partition system of this invention is in particular a partition system alternative to the traditional masonry or plasterboard walls. Prior art partition systems for dividing spaces are widely used for making rooms and/or corridors, for example for conference rooms and offices, and comprise a frame made with aluminium extruded profiles which are fixed to the floor, to the walls, and to the ceiling (or to the false ceiling) of the space, and one or more partition panels which are mounted on the profiles so as to make the walls; often there are one or more doorways made in the partition wall(s) with which hinged or sliding doors may be associated.

This invention was devised in particular in the context of glazed partition wall partition systems, in which one or more glass partition panels are used which define glazing with single or double panes, transparent or semi-transparent. Such partition systems have the advantage of allowing light diffusion through the partition walls and so making the rooms into which the space is divided brighter.

However, this invention is advantageously also applicable for making half-glazed or solid partition walls.

All prior art partition systems have the disadvantage of having limited soundproofing performance and so not being able to guarantee good sound insulation of one room relative to another.

In this context, the technical purpose which forms the basis of this invention is to obtain a partition system which at least partly overcomes the disadvantages of the prior art.

In particular, the technical purpose of this invention is to provide a partition system which allows one or more partition walls to be made with higher soundproofing performance.

The technical purpose specified and the aims indicated are substantially achieved by a partition system as defined in independent claim 1. Particular embodiments of this invention are defined in the corresponding dependent claims.

Further features and the advantages of this invention will be more apparent in the detailed description of several preferred, non-limiting embodiments of a partition system for dividing a space of a building into a plurality of rooms.

Reference will be made to the accompanying drawings, in which:

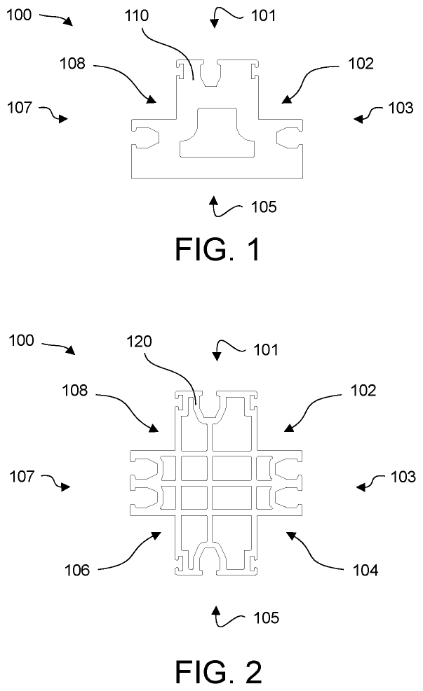

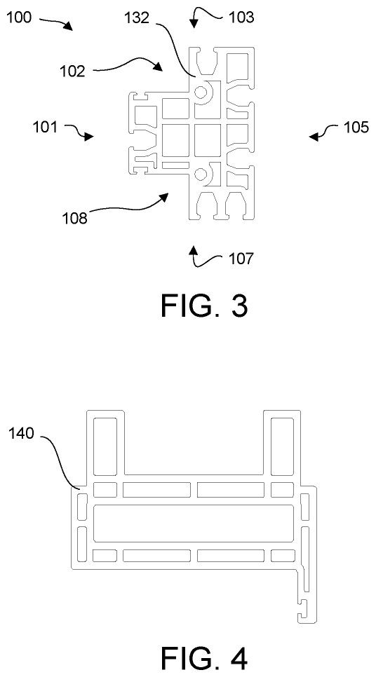

FIGS. 1 to 3 show, in cross-section, respectively a perimetric profile, an intermediate profile, and a jamb according to an embodiment of the partition system;

FIG. 4 shows, in cross-section, a horizontal crosspiece for a doorway according to an embodiment of the partition system;

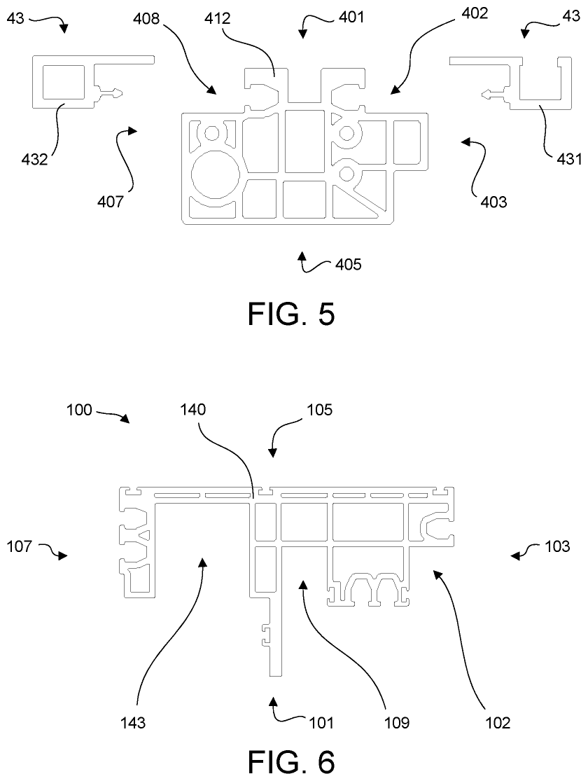

FIG. 5 shows, in cross-section, a horizontal member of a door and a plurality of inserts couplable to it according to an embodiment of the partition system;

FIG. 6 shows, in cross-section, a different horizontal crosspiece for a doorway according to an embodiment of the partition system;

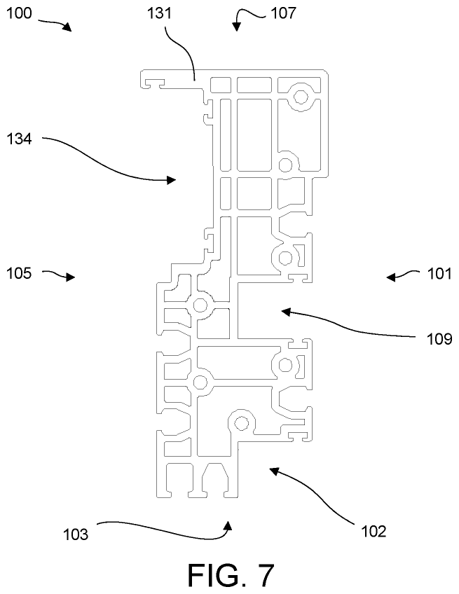

FIG. 7 shows, in cross-section, a different jamb according to an embodiment of the partition system;

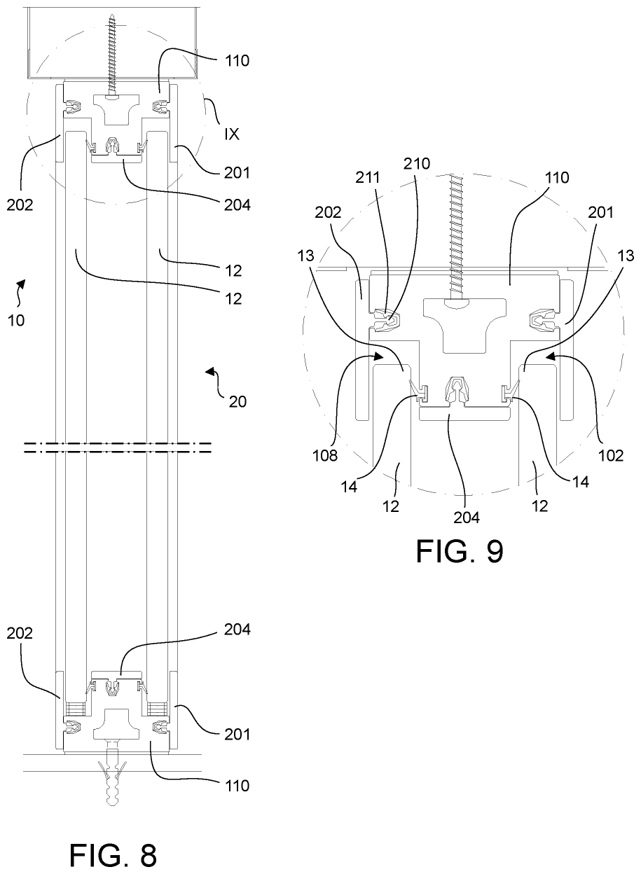

FIG. 8 shows, in vertical section, a double-panel partition wall which can be made with an embodiment of the partition system;

FIG. 9 is an enlarged view of the detail IX of FIG. 8;

FIG. 10 shows, in vertical section, a single-panel partition wall which can be made with an embodiment of the partition system;

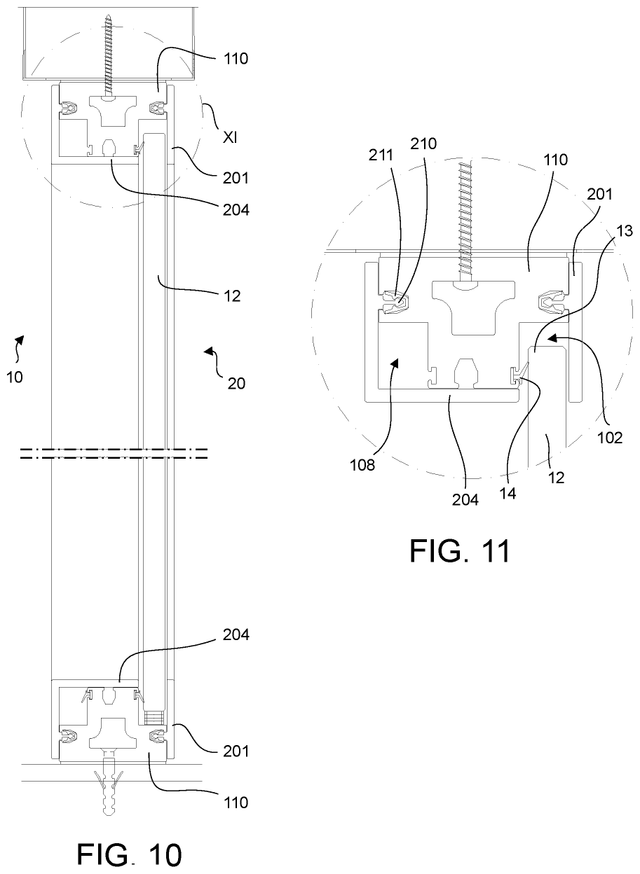

FIG. 11 is an enlarged view of the detail XI of FIG. 10;

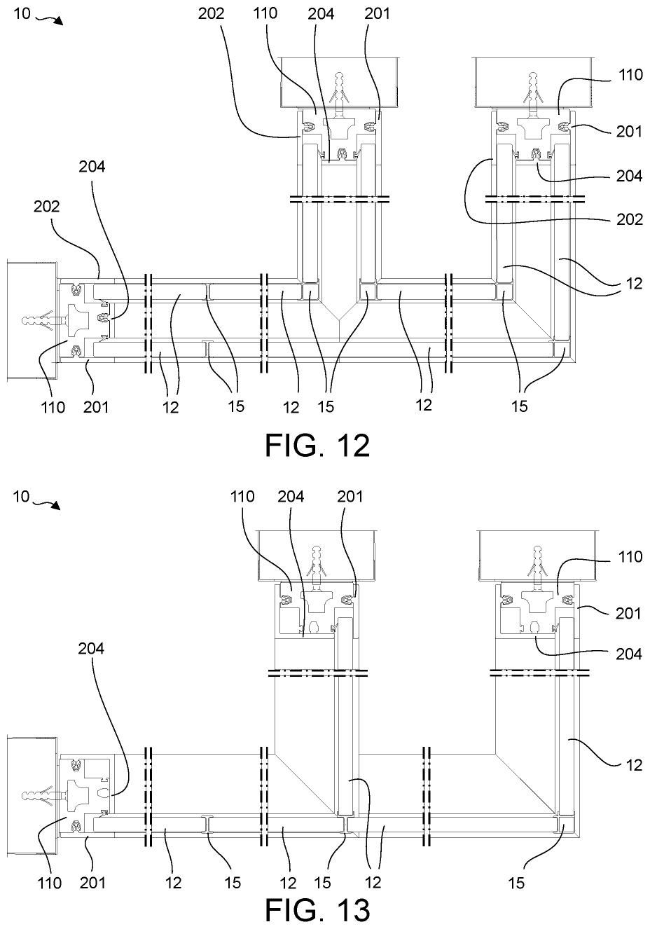

FIGS. 12 and 13 show, in horizontal section, respectively a double-panel partition wall and a single-panel partition wall which can be made with an embodiment of the partition system;

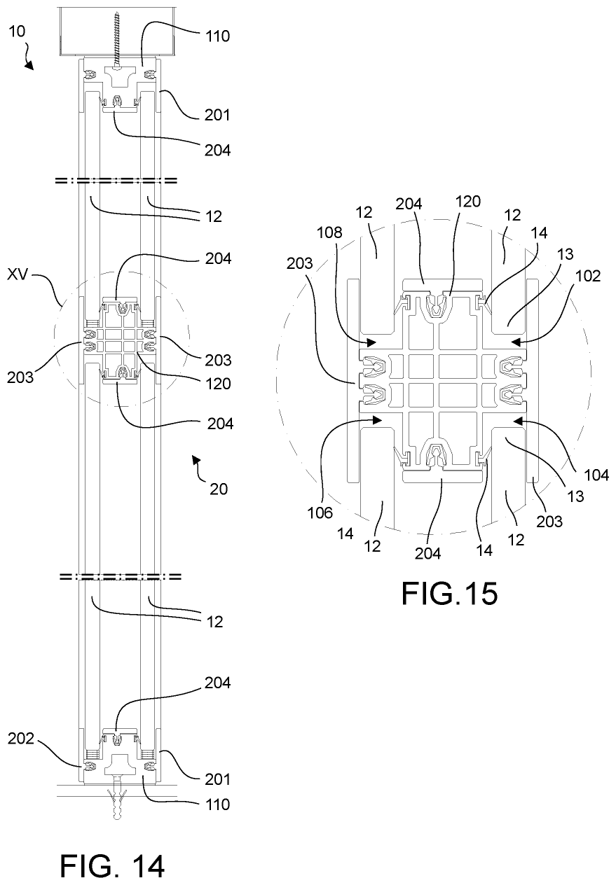

FIG. 14 shows, in vertical section, a double-panel partition wall which can be made with an embodiment of the partition system;

FIG. 15 is an enlarged view of the detail XV of FIG. 14;

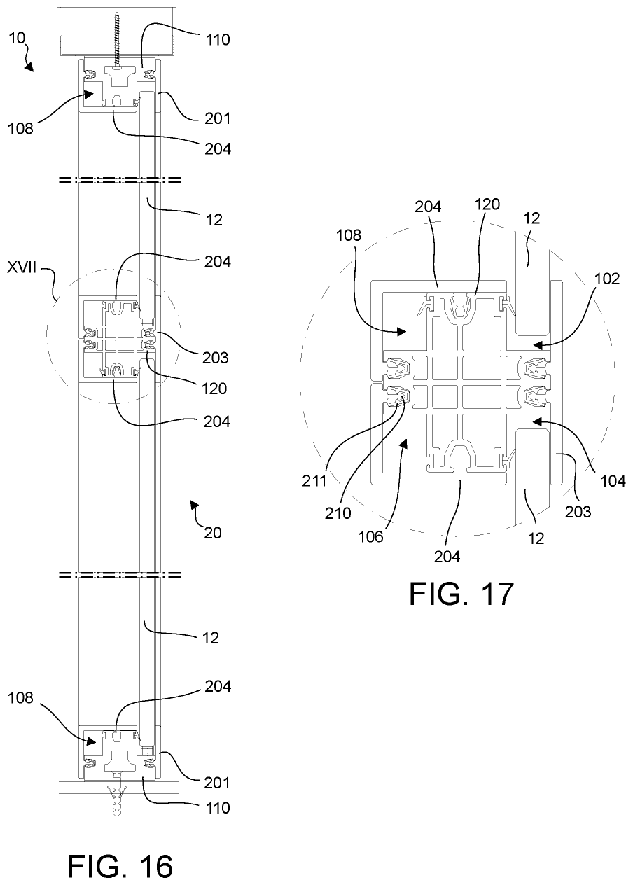

FIG. 16 shows, in vertical section, a single-panel partition wall which can be made with an embodiment of the partition system;

FIG. 17 is an enlarged view of the detail XVII of FIG. 16;

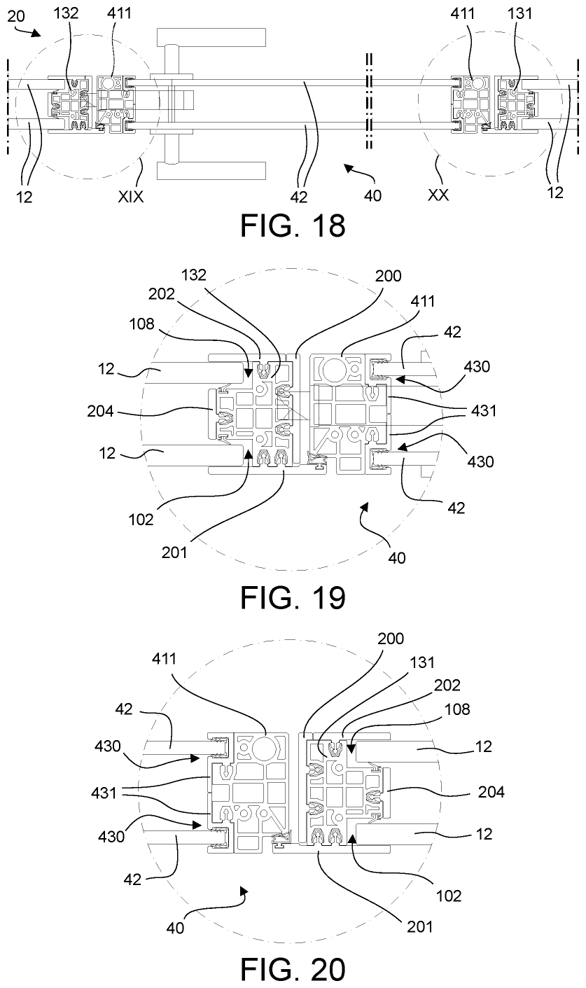

FIG. 18 shows, in horizontal section, a double-panel partition wall at a doorway and a double-panel hinged door in the closed position, according to an embodiment of the partition system;

FIGS. 19 and 20 show, enlarged, the details XIX and XX of FIG. 18;

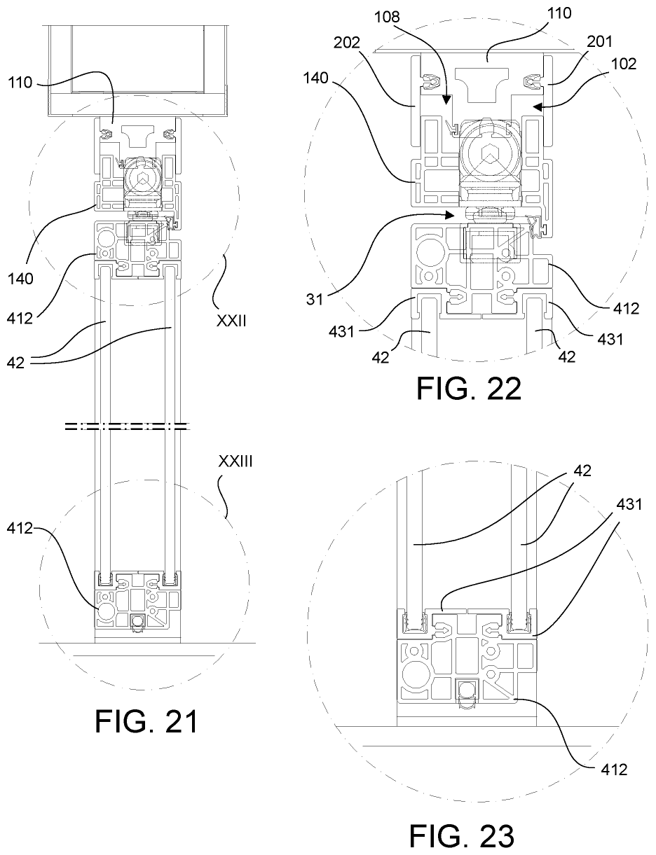

FIG. 21 shows, in vertical section at the doorway, the partition wall of FIG. 18;

FIGS. 22 and 23 show, enlarged, the details XXII and XXIII of FIG. 21;

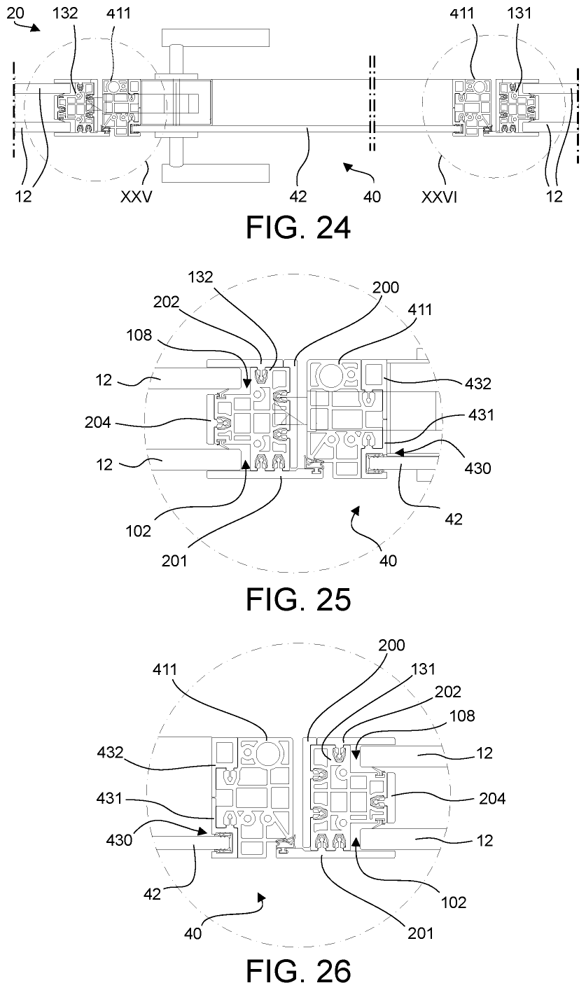

FIG. 24 shows, in horizontal section, a double-panel partition wall at a doorway and a single-panel hinged door in the closed position, according to an embodiment of the partition system;

FIGS. 25 and 26 show, enlarged, the details XXV and XXVI of FIG. 24;

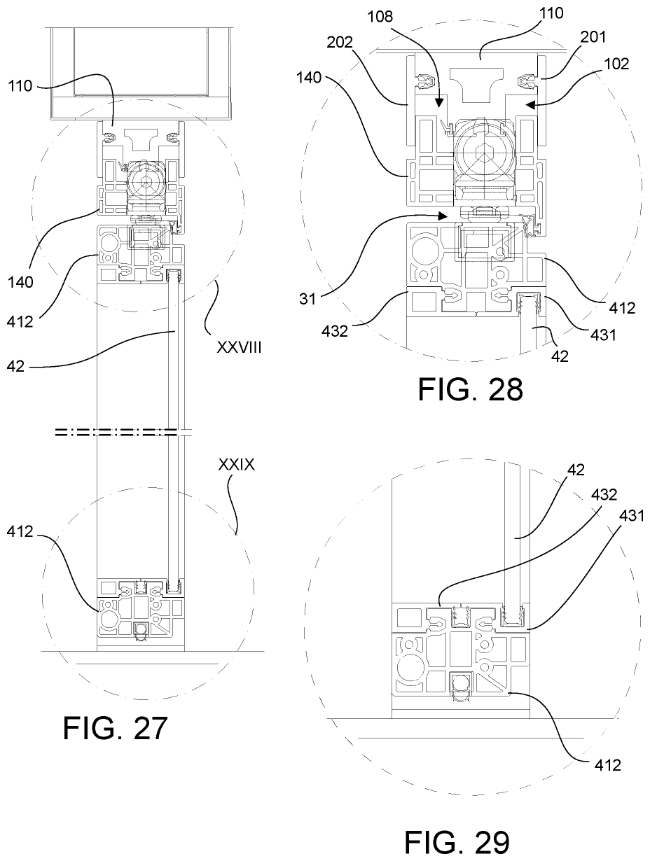

FIG. 27 shows, in vertical section at the doorway, the partition wall of FIG. 24;

FIGS. 28 and 29 show, enlarged, the details XXVIII and XXIX of FIG. 27;

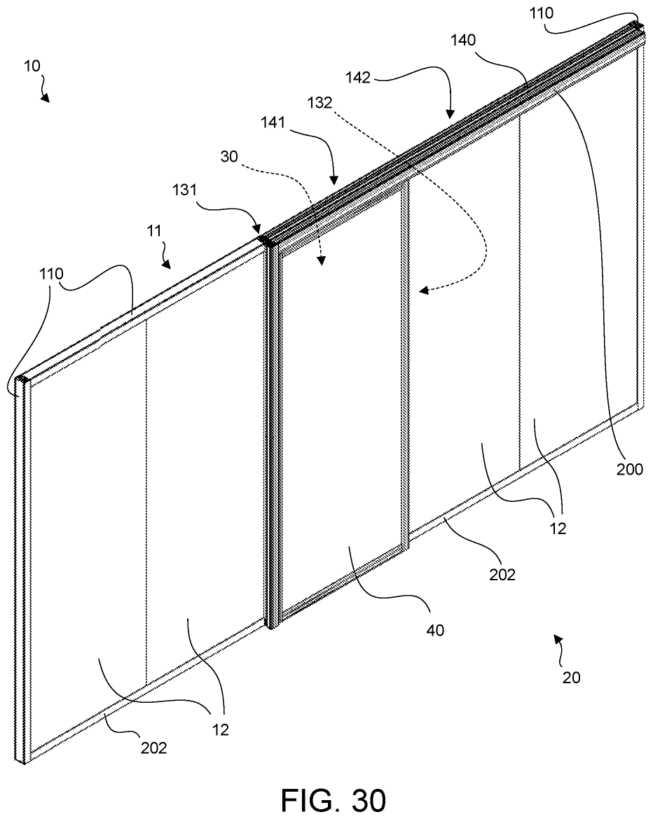

FIG. 30 shows, in an axonometric view, a double-panel partition wall with a doorway and a sliding door in the closed position;

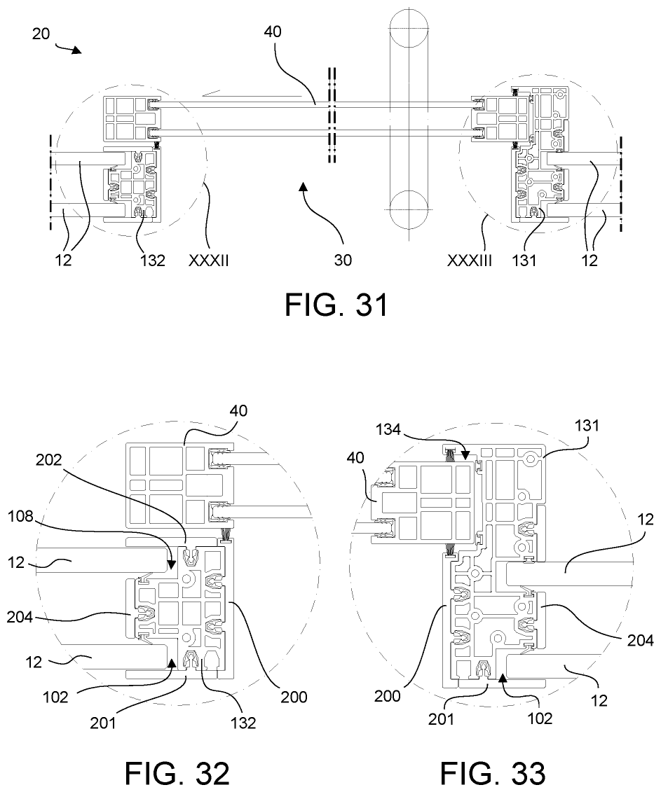

FIG. 31 shows, in horizontal section, the partition wall of FIG. 30 at the doorway;

FIGS. 32 and 33 show, enlarged, the details XXXII and XXXIII of FIG. 31;

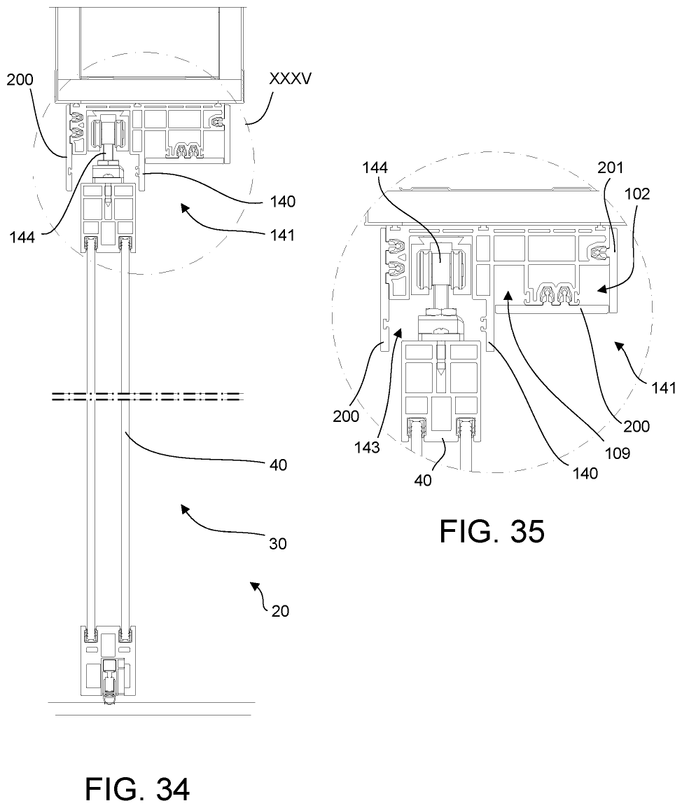

FIG. 34 shows, in vertical section at the doorway, the partition wall of FIG. 30 with the sliding door in the closed position;

FIG. 35 is an enlarged view of the detail XXXV of FIG. 34;

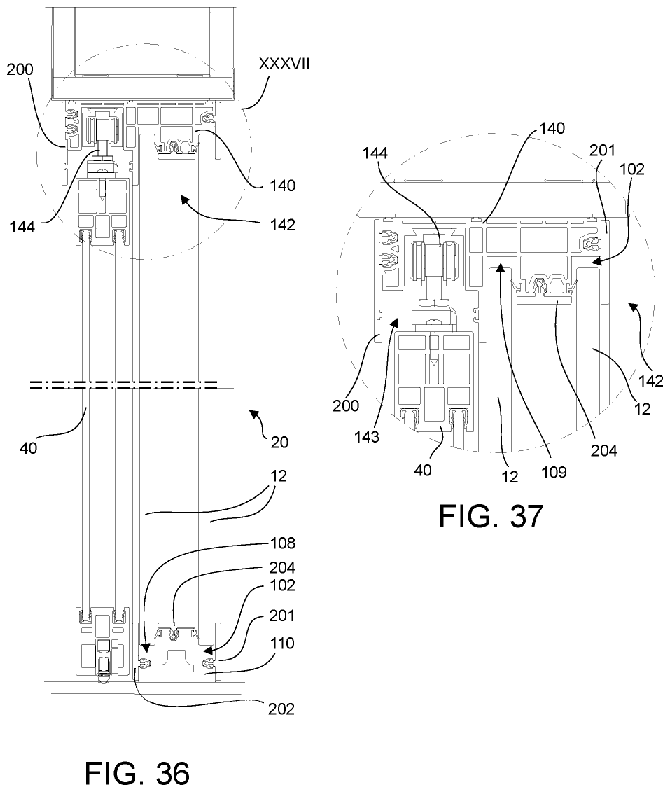

FIG. 36 shows, in vertical section next to the doorway, the partition wall of FIG. 30 with the sliding door in the open position;

FIG. 37 is an enlarged view of the detail XXXVII of FIG. 36;

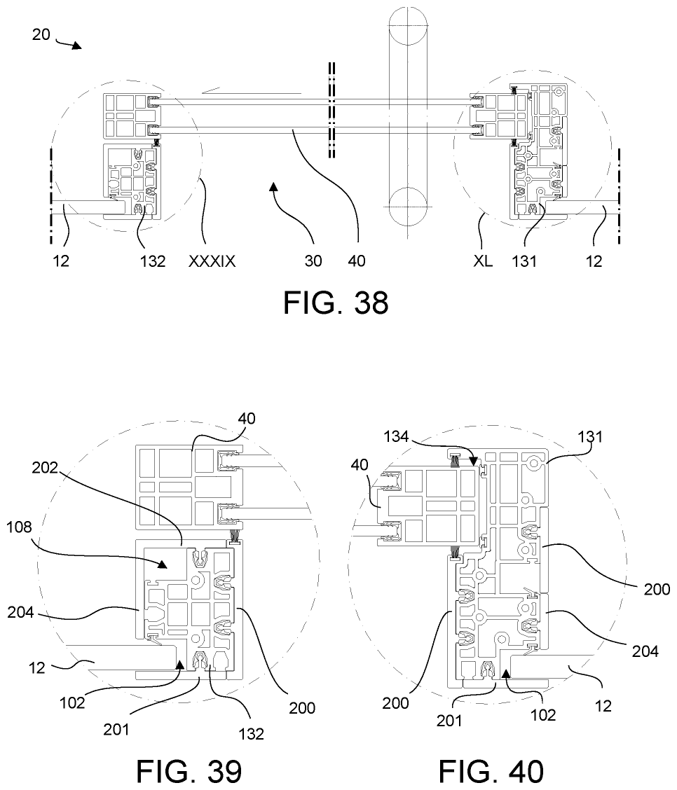

FIG. 38 shows a single-panel partition wall with a doorway and a sliding door, in the closed position, according to a horizontal section at the doorway;

FIGS. 39 and 40 show, enlarged, the details XXXIX and XL of FIG. 38;

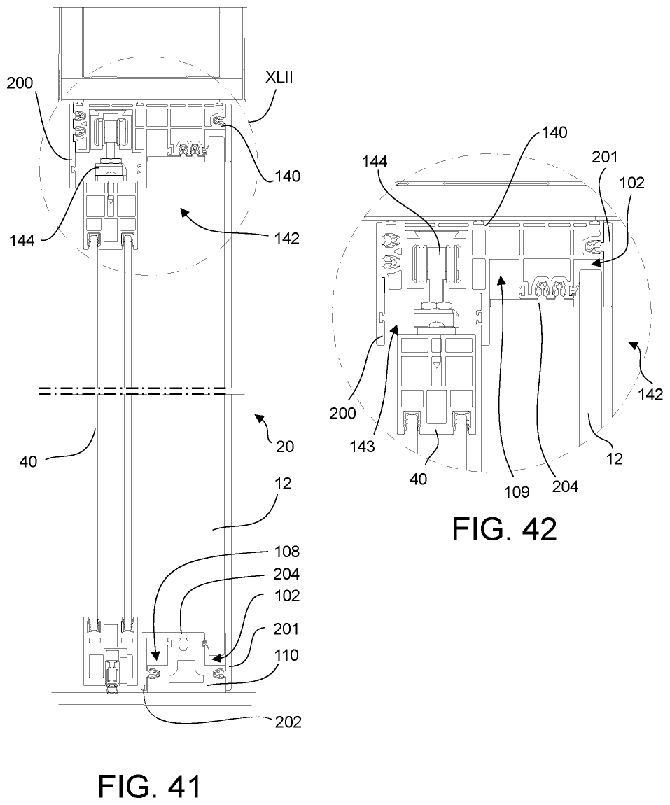

FIG. 41 shows, in vertical section next to the doorway, the partition wall of FIG. 38 with the sliding door in the open position;

FIG. 42 is an enlarged view of the detail XLII of FIG. 41.

With reference to the above-mentioned figures, the reference number 10 denotes in its entirety a partition system according to this invention.

The partition system 10 comprises a frame 11 and one or more partition panels 12 which are mountable on the frame 11. Depending on the type of partition wall 20 (glazed, half-glazed, solid), the one or more partition panels 12 may be made of glass or of a different type of material.

The frame 11 comprises a plurality of main profiles 100, each of which has a main line of extension along which it has a cross-section-perpendicularly to the main line of extension-which is substantially constant. Each main profile 100 has a front side 101, a first lateral flank 103, a rear side 105 which is opposite to the front side 101, and a second lateral flank 107 which is opposite to the first lateral flank 103 which all extend parallel to the main line of extension (examples of several embodiments of the main profiles 100 are illustrated in FIGS. 1 to 3, 6 and 7).

The front side 101 of each main profile 100 is associable, in use, with at least one of the one or more partition panels 12 and is advantageously configured for that purpose. Each partition panel 12 extends in a planar fashion and, when it is mounted on the frame 11, defines its own lying plane (ideal and infinite) which is advantageously parallel to the main line of extension of each main profile 100 with which the partition panel 12 is associated.

The plurality of main profiles 100 comprises at least one plurality of perimetric profiles 110, each of which is configured to be fixed, at its rear side 105, to a surface of the space. In the embodiments illustrated (for example, in FIG. 1), each perimetric profile 110 has, at the rear side 105, a flat surface which in use mates with the floor, or a wall, or the ceiling of the space to be divided up. When the partition system 10 is installed to form a partition wall 20, the perimetric profiles 110 are advantageously positioned in such a way as to define a perimetric frame of the partition wall 20 (see for example FIGS. 8, 12, 14 and 30).

Each main profile 100 delimits a first front hollow 102 which is open both on the first lateral flank 103, and on the front side 101; in use, the first front hollow 102 receives an edge 13 of at least one of the one or more partition panels 12. In the embodiments illustrated, the first front hollow 102 is advantageously delimited by two surfaces of the main profile 100 which, seen in cross-section, are positioned in an L shape.

In addition to the plurality of main profiles 100, the frame 11 comprises a plurality of covering profiles 200 which are couplable, by means of a snap joint, to the plurality of main profiles 100 in the ways described in more detail below and illustrated in the accompanying figures. In use, each covering profile 200 is advantageously couplable either to a single main profile 100, or to multiple main profiles 100 positioned with their main lines of extension coincident. In the embodiments illustrated (for example, in FIG. 9), the snap joint is made by inserting a projection 210 of the covering profile 200 into an elastic element 211 constrained to the main profile 100. Advantageously, the snap joint is reversible and the covering profiles 200 can be uncoupled from the main profiles 100, for example to be substituted with covering profiles 200 with a different colour or surface finish. Advantageously, the covering profiles 200 allow in use the colour and surface finish of the frame 11 visible to the user to be adapted to user needs, irrespective of the colour and surface finish of the main profiles 100 to which the covering profiles 200 are coupled. Preferably, each covering profile 200 is constituted of a material which is acrylonitrile butadiene styrene (ABS)-based and which comprises reinforcing fibres, for example glass fibres. Advantageously, the surface finish of each covering profile 200 is obtained by means of painting or other surface processing.

Advantageously, as illustrated in the accompanying figures, the partition system 10 comprises a plurality of types of covering profiles 200, each of which is usable in one or more contexts.

The plurality of covering profiles 200 comprises a plurality of first covers 201. Each first cover 201 is couplable to one of the main profiles 100 at the first lateral flank 103 in such a way as to at least partly cover the first lateral flank 103, and in such a way as to close the first front hollow 102 at the first lateral flank 103 obstructing removal of the partition panel 12 from the first front hollow 102. In detail, the first cover 201 is couplable in such a way as to obstruct removal of the partition panel 12 along a line perpendicular to the lying plane of the partition panel 12 (coming out relative to the first lateral flank 103).

In the partition system 10, in accordance with this invention, one or more of the perimetric profiles 110 are constituted of a main material which is thermoplastic polyolefin mixture-based; preferably, all of the perimetric profiles 110 are constituted of the main material. The thermoplastic polyolefin mixture comprises two or more thermoplastic polymers which belong to the class of polyolefins.

In some preferred embodiments, the thermoplastic polyolefin mixture comprises at least two polymers selected from low density polyethylene (low density polyethylene, LDPE, and/or linear low density polyethylene, LLDPE), high density polyethylene (HDPE) and polypropylene (PP).

Preferably, the thermoplastic polyolefin mixture comprises, or is constituted of, between 55% and 75% low density polyethylene (LDPE and/or LLDPE), between 20% and 40% high density polyethylene (HDPE), and between 1% and 10% polypropylene (PP); the percentages are by weight.

In one preferred embodiment, the thermoplastic polyolefin mixture is a mixture of recycled polymers to reduce the environmental impact of the partition system 10.

Advantageously, the main material also comprises reinforcing fibres to improve the mechanical properties and, preferably, the soundproofing performance of the partition system 10. For example, it is possible to use fibres made of glass or other material, continuous fibres aligned with the main line of extension of the perimetric profile 110, or randomly aligned short fibres. In some embodiments, one or more of the main profiles 100 are constituted of a material which is acrylonitrile butadiene styrene (ABS)-based and which comprises reinforcing fibres; those one or more of the main profiles 100 are main profiles 100 which are different from the one or more perimetric profiles 110 constituted of the main material.

In some embodiments in which one or more of the main profiles 100 and/or the covering profiles 200 are constituted of an acrylonitrile butadiene styrene (ABS)-based material, the acrylonitrile butadiene styrene (ABS) is advantageously of the recycled type to reduce the environmental impact of the partition system 10.

In some embodiments, at least one main profile 100 also delimits a second front hollow 108 which is open both on the second lateral flank 107, and on the front side 101; the second front hollow 108 is suitable for receiving, in use, an edge 13 of at least one of the one or more partition panels 12. In the embodiments illustrated, the second front hollow 108 is advantageously delimited by two surfaces of the main profile 100 which, seen in cross-section, are positioned in an L shape, and is symmetrical relative to the first front hollow 102; in the case of a perimetric profile 130, the perimetric profile 130 is advantageously a T-shaped profile. Advantageously, a plurality of main profiles 100 each delimits the second front hollow 108, preferably all of them. At least one covering profile 200 is a second cover 202 couplable to the main profile 100 at the second lateral flank 107 in such a way as to at least partly cover the second lateral flank 107, and in such a way as to close the second front hollow 108 at the second lateral flank 107 obstructing removal of the partition panel 12 from the second front hollow 108. That second cover 202 is couplable in such a way as to obstruct removal along a line perpendicular to the lying plane of the partition panel 12 (coming out relative to the second lateral flank 107) whose edge 13 is received in the second front hollow 108. In some embodiments, the first covers 201 and the second covers 202 are identical and interchangeable (see for example FIG. 9).

In some embodiments, the partition system 10 comprises a plurality of partition panels 12, and the plurality of main profiles 100 also comprises an intermediate profile 120 whose rear side 105 is associable in use with at least one of the plurality of partition panels 12. In addition to the first front hollow 102, the intermediate profile 120 also delimits a first rear hollow 104 which is open both on the first lateral flank 103, and on the rear side 105; the first rear hollow 104 receives, in use, an edge 13 of said at least one of the plurality of partition panels 12 associable with the rear side 105 of the intermediate profile 120. In the embodiments illustrated, the first rear hollow 104 is advantageously delimited by two surfaces of the intermediate profile 120 which, seen in cross-section, are positioned in an L shape, and is symmetrical relative to the first front hollow 102.

At least one covering profile 200 is a third cover 203 couplable to the intermediate profile 120 at the first lateral flank 103 in such a way as to close the first rear hollow 104 at the first lateral flank 103 obstructing removal of the partition panel 12 from the first rear hollow 104. That third cover 203 is couplable in such a way as to obstruct removal along a line perpendicular to the lying plane of the partition panel 12 (coming out relative to the first lateral flank 103) whose edge 13 is received in the first rear hollow 104.

In some embodiments, the third cover 203 is couplable to the intermediate profile 120 at the first lateral flank 103 and is configured in such a way as to close at the first lateral flank 103 both the first front hollow 102, and the first rear hollow 104, obstructing removal, from each of the first front hollow 102 and the first rear hollow 104, of the respective partition panel 12.

In the assembled partition wall 20, the intermediate profile 120 may be positioned horizontally or vertically in an intermediate position between two perimetric profiles 110 opposite each other (one fixed to the ceiling and the other to the floor, or fixed to two opposite lateral walls of the space), separating two or more partition panels 50 (see for example FIG. 14).

In some embodiments, the intermediate profile 120 also itself delimits a second front hollow 108 and a second rear hollow 106 which is open both on the second lateral flank 107, and on the rear side 105; the second rear hollow 106 is suitable for receiving, in use, an edge 13 of at least one of the one or more partition panels 12. In the embodiments illustrated, the second rear hollow 106 is advantageously delimited by two surfaces of the intermediate profile 120 which, seen in cross-section, are positioned in an L shape, and is symmetrical relative to the second front hollow 108 and to the first rear hollow 104; advantageously the intermediate profile 120 is a cross-shaped profile (FIG. 2).

At least one covering profile 200 is couplable to the main profile 100 at the second lateral flank 107 in such a way as to at least partly cover the second lateral flank 107, and in such a way as to close the second rear hollow 106 at the second lateral flank 107 obstructing removal of the partition panel 12 from the second rear hollow 106. That covering profile 200 is couplable in such a way as to obstruct removal along a line perpendicular to the lying plane of the partition panel 12 (coming out relative to the second lateral flank 107) whose edge 13 is received in the second rear hollow 106.

In some embodiments, that covering profile is couplable to the intermediate profile 120 at the first lateral flank 103 and is configured in such a way as to close at the first lateral flank 103 both the second front hollow 108, and the second rear hollow 106, obstructing removal, from each of the second front hollow 108 and the second rear hollow 106, of the respective partition panel 12. In some embodiments the covering profile in question is a third cover 203 (FIG. 15).

Advantageously, when there is a plurality of main profiles 100 which each delimit a respective second front hollow 108, and if necessary a respective first rear hollow 104 and a respective second rear hollow 106, those main profiles 100 may be used to make, for example, a partition wall 20 with double partition panels 12 (for example with double panes), or alternatively a wall with a single partition panel (see for example FIGS. 8 to 17).

In some embodiments, at least one covering profile 200 is a fourth cover 204 couplable to one of the main profiles 100 in such a way as to partly cover at least one of either the front side 101 or the rear side 105 of the one of the main profiles 100. In some embodiments, the fourth cover 204 is couplable to one of the main profiles 100 in such a way as to also cover, at least partly, the second lateral flank 107 of the one of the main profiles 100 and, if present, the second front hollow 108 or the second rear hollow 106 (advantageous solution in the case of walls with single partition panel).

When coupled to partly cover the front side 101 of a main profile 100, the fourth cover 204 leaves open on the front side 101 the first front hollow 102 allowing the edge 13 of a partition panel 12 to be received in the first front hollow 102. When coupled to partly cover the front side 101 of a main profile 100 which delimits a second front cover 108, the fourth cover 204 may leave open on the front side 101 the first front hollow 102 and the second front hollow 108 allowing an edge 13 of a partition panel 12 to be received in each of them (for example to make a wall with double panes; see FIGS. 9 and 15). In some embodiments, the fourth cover 204 may in contrast close the second front hollow 102 on the front side 101 and on the second lateral flank 107 hiding it from view (for example to make a wall with single pane; see FIGS. 11 and 17).

When coupled to partly cover the rear side 105 of an intermediate profile 120, the fourth cover 204 leaves open on the rear side 105 the first rear hollow 104 allowing an edge 13 of a partition panel 12 to be received in the first front hollow 102. When coupled to partly cover the rear side 105 of an intermediate profile 120 which delimits a second rear hollow 106, the fourth cover 204 may leave open on the rear side 105 the first rear hollow 104 and the second rear hollow 106 allowing an edge 13 of a partition panel 12 to be received in each of them (for example to make a wall with double panes; see FIG. 15). In some embodiments, the fourth cover 204 may in contrast close the second rear hollow 106 on the rear side 105 and on the second lateral flank 107 hiding it from view (for example to make a wall with single pane; see FIG. 17).

In general, when a main profile 100 is in use associated with a plurality of partition panels 12 (at the front side 101 and if necessary at the rear side 105), and when the same main profile 100 delimits—in addition to the first front hollow 102—also the second front hollow 108 and/or the first rear hollow 104 and/or the second rear hollow 106, each of the partition panels 12 is received at the respective edge 13 in only one of those hollows delimited by that main profile 100. Advantageously, each of those hollows delimited by that main profile 100 may in use receive an edge 13 of a plurality of partition panels 12 positioned coplanar, for example to make a partition wall 20 in which a plurality of vertical partition panels 12 are mounted alongside each other without them being separated by a component of the frame 11 but, if necessary, only by a connecting joint such as a polycarbonate profile 15 (as illustrated in FIGS. 12 and 13).

In some embodiments, the frame 11 comprises a first jamb 131 and a second jamb 132, which are part of the plurality of main profiles 100, and a horizontal crosspiece 140; the first jamb 131, the second jamb 132 and the horizontal crosspiece 140 are connectable to each other to define in use a doorway 30, with the rear sides 105 of the first and of the second jambs 131, 132 positioned at an inner edge of the doorway 30. In the context of this invention, doorway 30 means an opening in the partition wall 20 which allows passage from one side of the partition wall 20 to the other. For each of the first and the second jambs 131, 132, at least one of the covering profiles 200 is couplable to the jamb 131, 132 in such a way as to at least partly cover the rear side 105. In use, each of the first and the second jambs 131, 132 is covered at the rear side 105 by a respective covering profile 200.

In some embodiments, the partition system 10 also comprises a door 40 which, in use, is associated with the doorway 30 and is movable between an open position, in which it allows passage through the doorway 30, and a closed position, in which it is coupled to the doorway 30 and prevents passage through the doorway 30.

In some embodiments (see for example FIGS. 18 to 29), the door 40 comprises a supporting structure 41, which comprises two vertical uprights 411 and two horizontal members 412, at least one door panel 42 mounted on the supporting structure 41, and a plurality of inserts 43. Each of the two vertical uprights 411 and of the two horizontal members 412 has an inner side 401, a first flank 403, an outer side 405 which is opposite to the inner side 401, and a second flank 407 which is opposite to the first flank 403; the outer side 405 of each upright/member 411, 412 is at an outer edge 410 of the door 40. Each of the two vertical uprights 411 and of the two horizontal members 412 delimits a first inner hollow 402, which is open on the inner side 401 and on the first flank 403, and a second inner hollow 408, which is open on the inner side 401 and on the second flank 407. Each first inner hollow 402 and each second inner hollow 408 receives one of the inserts 43. The plurality of inserts 43 is coupled by means of a snap joint (in the embodiments illustrated, in the ways already described) to the supporting structure 41, and at least one part of the plurality of inserts 43 defines a housing 430 in which, in use, an edge of the at least one door panel 42 is inserted and retained.

The door 40 may be of the single-panel or double-panel type. The plurality of inserts 43 advantageously comprises hollow inserts 431 and covering inserts 432, in such a way that, when the door 40 comprises a single door panel 42, a plurality of hollow inserts 431 coupled to the first inner hollow 402 defines the housing 430 for the door panel 42, whilst a plurality of covering inserts 432 coupled to the second inner hollows 408 hides the latter from view. When the door 40 comprises two door panels 42, a plurality of hollow inserts 431 is coupled both to the first inner hollows 402, and to the second inner hollows 408 defining two housings 430 for two door panels 42 (one at the first inner hollows 402, and one at the second inner hollows 408).

In some embodiments the door 40 is connectable to the doorway 30 by means of a hinge and, if necessary, by means of a return arm 31.

In some embodiments (see for example FIGS. 30 to 42), the partition system 10 comprises a door 40 which is slidable between the open position and the closed position. In those embodiments, the horizontal crosspiece 140 is a main profile 100, and comprises a first portion 141, which in use extends between the first and the second jambs 131,132 (along the main line of extension), and a second portion 142 which in use extends cantilever-style beyond the second jamb 132 (along the main line of extension). Moreover, the horizontal crosspiece 140 delimits a channel 143 which extends along the first portion 141 and the second portion 142: the channel 143 is open on the front side 101 (which in use is directed downwards) and is configured to receive in use a sliding mechanism 144 for the (sliding) door 40. The channel 143 extends along the main line of extension preferably parallel to the first front hollow 102 of the horizontal crosspiece 140. At least one covering profile 200 is couplable to the first portion 141 of the horizontal crosspiece 140 for closing the first front hollow 102 at the doorway 30 and at the front side 101 (FIGS. 34 and 35). In contrast, the first front hollow 102 of the horizontal crosspiece 140 receives, in use, the edge 13 of one or more partition panels 12 at the second portion 142 (FIGS. 36 and 37). The door 40, when in use it slides between the open position and the closed position, slides parallel to the one or more partition panels 12 received in the first front hollow 102.

Advantageously, in order to make for example a double-panel partition wall 20, the horizontal crosspiece 140 also delimits a central hollow 109 which is open on the front side 101; advantageously, the central hollow is interposed between the first front hollow 102 and the channel 143, for receiving in use further one or more partition panels 12 (FIGS. 6, 36 and 37).

Preferably, the first jamb 131 also delimits, at the rear side 105, a seat 134 which is open and which, in use, receives an outer edge 410 of the (sliding) door 40 when the latter is in the closed position.

At least in these embodiments, in use both the part of the horizontal crosspiece 140 which delimits the channel 143, and the seat 134 are advantageously positioned cantilever-style relative to the rest of the wall to which they belong.

Advantageously, and similarly to some embodiments of the horizontal crosspiece 140, the first jamb 131 delimits a central hollow 109 which is open on the front side 101 for receiving in use further one or more partition panels 12.

Preferably, at least one of each main profile 100 and the one or more covering profiles 200 couplable to it in such a way as to obstruct removal of the partition panels 12 from the respective hollows, is equipped with a gasket 14 by means of which it makes contact with the respective partition panels 12.

One advantage of different embodiments of the partition system 10 described above is its modularity: by using a limited number of elements, the partition system 10 can allow partition walls to be made which differ from each other based on the combination of those elements. For example, with the same partition system 10 it is possible to make a single-panel or double-panel (glazed or solid) partition wall 20, with a doorway 30 and with a single-panel or double-panel door 40, sliding or fixed by means of hinges.

The invention described above may be modified and adapted in several ways without thereby departing from the scope of the inventive concept as defined in the independent claims.

All details may be substituted with other technically equivalent elements and the materials used, as well as the shapes and dimensions of the various components, may vary according to requirements.

1. A partition system (10) for dividing a space of a building into a plurality of rooms, comprising a frame (11) and one or more partition panels (12) mountable on the frame (11), wherein:
the frame (11) comprises a plurality of main profiles (100), each main profile (100) having a front side (101) in use associable with at least one of the one or more partition panels (12), a first lateral flank (103), a rear side (105) which is opposite to the front side (101), and a second lateral flank (107) which is opposite to the first lateral flank (103);
the plurality of main profiles (100) comprises at least one plurality of perimetric profiles (110), each perimetric profile being configured to be fixed at the rear side (105) to a surface of the space;
each main profile (100) delimits a first front hollow (102) which is open both on the first lateral flank (103), and on the front side (101);
in use, the first front hollow (102) receives an edge (13) of at least one of the one or more partition panels (12);
the frame (11) also comprises a plurality of covering profiles (200) which are couplable by means of a snap joint to the plurality of main profiles (100);
the plurality of covering profiles (200) comprises a plurality of first covers (201), each first cover (201) being couplable to one of the main profiles (100) at the first lateral flank (103) in such a way as to at least partly cover the first lateral flank (103) and to close said first front hollow (102) at the first lateral flank (103) obstructing removal of the partition panel (12) from the first front hollow (102); and
one or more of the perimetric profiles (110) are constituted of a main material which is thermoplastic polyolefin mixture-based.

2. The partition system (10) according to claim 1, wherein the thermoplastic polyolefin mixture comprises at least two polymers selected from low density polyethylene, high density polyethylene and polypropylene.

3. The partition system (10) according to claim 2, wherein the thermoplastic polyolefin mixture comprises, or is constituted of, between 55% and 75% low density polyethylene, between 20% and 40% high density polyethylene, and between 1% and 10% polypropylene.

4. The partition system (10) according to claim 1, wherein the main material also comprises reinforcing fibres.

5. The partition system (10) according to claim 1, wherein one or more of the main profiles (100) are constituted of a material which is acrylonitrile butadiene styrene-based and which comprises reinforcing fibres.

6. The partition system (10) according to claim 1, wherein:
at least one main profile (100) also delimits a second front hollow (108) which is open both on the second lateral flank (107), and on the front side (101);
that second front hollow (108) is suitable for receiving, in use, an edge (13) of at least one of the one or more partition panels (12); and
at least one covering profile (200) is a second cover (202) couplable to said at least one main profile (100) at the second lateral flank (107) in such a way as to at least partly cover the second lateral flank (107) and to close said second front hollow (108) at the second lateral flank (107) obstructing removal of the partition panel (12) from the second front hollow (108).

7. The partition system (10) according to claim 1, comprising a plurality of partition panels (12), wherein moreover:
the plurality of main profiles (100) also comprises an intermediate profile (120);
the rear side (105) of the intermediate profile (120) is associable in use with at least one of the plurality of partition panels (12);
the intermediate profile (120) also delimits a first rear hollow (104) which is open both on the first lateral flank (103), and on the rear side (105);
in use, that first rear hollow (104) receives an edge (13) of said at least one of the plurality of partition panels (12) associable with the rear side (105) of the intermediate profile (120); and
at least one covering profile (200) is a third cover (203) couplable to the intermediate profile (120) at the first lateral flank (103) in such a way as to close the first rear hollow (104) at the first lateral flank (103) obstructing removal of the partition panel from the first rear hollow (104).

8. The partition system (10) according to claim 7, wherein the third cover (203) is couplable to the intermediate profile (120) at the first lateral flank (103) and is configured in such a way as to close at the first lateral flank (103) both the first front hollow (102), and the first rear hollow (104), obstructing removal, from each of the first front hollow (102) and the first rear hollow (104), of the respective partition panel (12).

9. The partition system (10) according to claim 1, wherein at least one covering profile (200) is a fourth cover (204) couplable to one of the main profiles (100) in such a way as to partly cover at least one of either the front side (101) or the rear side (105) of the one of the main profiles (100).

10. The partition system (10) according to claim 9, wherein the fourth cover (204) is couplable to one of the main profiles (100) in such a way as to also cover, at least partly, the second lateral flank (107) of the one of the main profiles (100).

11. The partition system (10) according to claim 1, wherein each covering profile (200) is constituted of a material which is acrylonitrile butadiene styrene-based and which comprises reinforcing fibres.

12. The partition system (10) according to claim 1, wherein:
the plurality of main profiles (100) also comprises a first jamb (131) and a second jamb (132);
the frame (11) also comprises a horizontal crosspiece (140);
the first jamb (131), the second jamb (132) and the horizontal crosspiece (140) are connectable to each other to define in use a doorway (30), with the rear sides (105) of the first and of the second jambs (131, 132) at an inner edge of the doorway (30); and
for each of the first and the second jambs (131, 132), at least one of the covering profiles (200) is couplable to the jamb in such a way as to at least partly cover the rear side (105).

13. The partition system (10) according to claim 12, also comprising a door (40) which in use is associated with the doorway (30) and is movable between an open position in which it allows passage through the doorway (30) and a closed position in which it is coupled to the doorway (30) and prevents passage through the doorway (30); wherein moreover:
the door (40) comprises a supporting structure (41) which comprises two vertical uprights (411) and two horizontal members (412), at least one door panel (42) mounted on the supporting structure (41), and a plurality of inserts (43);
each of the two vertical uprights (411) and of the two horizontal members (412) has an inner side (401), a first flank (403), an outer side (405) which is opposite to the inner side (401), and a second flank (407) which is opposite to the first flank (403); the outer side (405) being at an outer edge (410) of the door (40);
each of the two vertical uprights (411) and of the two horizontal members (412) delimits a first inner hollow (402) and a second inner hollow (408), the first inner hollow (402) being open on the inner side (401) and on the first flank (403), the second inner hollow (408) being open on the inner side (401) and on the second flank (407);
each first inner hollow (402) and each second inner hollow (408) receives one of the inserts (43);
the plurality of inserts (43) is coupled by means of a snap joint to the supporting structure (41); and
at least one part of the plurality of inserts (43) defines a housing (430) in which an edge of the at least one door panel (42) is inserted and retained.

14. The partition system (10) according to claim 12, also comprising a door (40) which in use is associated with the doorway (30) and which is slidable between an open position in which it allows passage through the doorway (30) and a closed position in which it is coupled to the doorway (30) and prevents passage through the doorway (30), wherein moreover:
the horizontal crosspiece (140) is a main profile (100);
the horizontal crosspiece (140) comprises a first portion (141) which in use extends between the first and the second jambs (132), and a second portion (142) which in use extends cantilever-style beyond the second jamb (132);
the horizontal crosspiece (140) delimits a channel (143) which extends along the first portion (141) and the second portion (142);
the channel (143) is open on the front side (101) and is configured to receive in use a sliding mechanism (144) for the door (40);
at least one covering profile (200) is couplable to the first portion (141) of the horizontal crosspiece (140) for closing the first front hollow (102) at the doorway (30) and at the front side (101), the first front hollow (102) of the horizontal crosspiece (140) receiving, in use, the edge (13) of the at least one of the one or more partition panels (12) at the second portion (142).

15. The partition system (10) according to claim 14, wherein the first jamb (131), at the rear side (105), also delimits a seat (134) which is open and which, in use, receives an outer edge (410) of the door (40) when the latter is in the closed position.
